(19) United States
(12) Patent Application Publication
(10) Pub. No.: US 2011/0279274 A1
(43) Pub. Date: Nov. 17, 2011

(54) RFID READER

(75) Inventors: Jae Hwan IM, Gwangmyeong (KR); Hun PARK, Anyang (KR); Hak Min Seo, Seoul (KR)

(73) Assignee: LSIS CO., LTD.

(21) Appl. No.: 13/101,079

(22) Filed: May 4, 2011

(30) Foreign Application Priority Data
May 17, 2010 (KR) 10-2010-0046172

(51) Int. Cl. G08B 13/14

(52) U.S. Cl. 340/572.7

(57) ABSTRACT

A radio frequency identification (RFID) reader includes an antenna unit and a signal processing unit. The antenna unit splits an input RF signal into a plurality of signals and respectively transmit the split signals through a plurality of antennae by setting the amplitudes or phases of the split signals to be different from one another. The signal processing unit is connected to the antenna unit through one transmission line, and transmits an RF signal to which a DC signal is added to the antenna unit. Accordingly, the amplitude and phase of the RF signal are set variable, so that it is possible to extend the identification range by dynamically controlling an antenna radiation pattern of the RFID reader and to stably communicate with the tag by decreasing the error rate of reception data.

### CROSS-REFERENCE TO RELATED APPLICATION

This application claims the benefit of Korean Patent Application No. 10-2010-0046172, filed May 17, 2010, the disclosure of which is hereby incorporated herein by reference in its entirety.

### BACKGROUND OF THE DISCLOSURE

1. Field of the Disclosure

An aspect of the present disclosure relates to a radio frequency identification (RFID) reader.

2. Description of the Related Art

Radio frequency identification (RFID) is a technology that provides a base capable of identifying, tracking and controlling a remote object by identifying a tag attached to the object using a radio frequency (RF) transmission. The RFID is a non-contact automatic identification technology using a radio wave that identifies an object by attaching a microchip and an antenna to the object. In the RFID, an object can always be identified regardless of the package state of the object, the material of the surface of the object, the presence of change in environment, and the like. In addition, the RFID has advantages of a larger amount of information exchange, long identification distance and transmission of obstacles except metal as compared with the existing bar code system. The RFID has recently come into the spotlight as a next-generation technology in the industry fields, thanks to the many advantages.

An RFID system uses various frequency bands including low frequency (125 kHz, 135 kHz), high frequency (13.56 MHz), UHF (433 MHz, 860 to 960 MHz) and microwave (2.4 GHz), and their usages and applications are different from one another. Among these frequency bands, the UHF band is extended to all fields of life including distribution and logistics because of long-distance signal transmission and relatively high-speed transmission.

The RFID system usually includes an RFID reader and tags. The RFID reader is provided with an embedded or external antenna. The antenna forms an electromagnetic wave, i.e., an RF field by emitting an active signal. If a tag enters the RF field, the tag receives the active signal emitted from the antenna of the RFID reader and transmits information stored in the tag to the RFID reader using the received active signal. Then, the RFID reader receives and analyzes the information transmitted from the tag, thereby obtaining identification(ID) information of an object to which the tag is attached.

The ID information of the object, obtained by the RFID reader provides a base which can be effectively used in logistics/distribution management including distribution, assembly, price variation, sale, and the like.

However, in the communication between the tag and the RFID reader, a change in radio wave environment occurs, e.g., existence of a reflective wave caused by the position and speed of the tag passing through the RF field, the package material of an object having the tag attached thereto, the ground, or the like. According to the change in radio wave environment, a difference is generated in error rate of data received by the RFID, stability, identification distance, or the like. Therefore, the difference becomes a main cause of decreasing the identification rate of electronic tags and lowering the reliability of the RFID system.

### SUMMARY OF THE DISCLOSURE

Embodiments of the present disclosure provide an RFID reader which can extend the identification range of a tag by dynamically controlling an antenna radiation pattern of the RFID reader and stably communicate with the tag by decreasing the error rate of reception data.

According to an aspect of the present disclosure, there is provided an RFID reader including: an antenna unit configured to split an input RF signal into a plurality of signals and respectively transmit the split signals through a plurality of antennae by setting the amplitudes or phases of the split signals to be different from one another, and a signal processing unit connected to the antenna unit through one transmission line, the signal processing unit transmitting an RF signal to which a DC signal is added to the antenna unit.

In some exemplary embodiments of the present disclosure, the antenna unit may include an RF/DC separator configured to receive the RF signal from the signal processing unit so as to separately output the DC signal and the RF signal, an RF splitter configured to split the RF signal inputted from the RF/DC separator into a plurality of signals, and a plurality of phase shifters configured to adjust the phases of the plurality of signals inputted from the RF splitter.

In some exemplary embodiments of the present disclosure, the antenna unit may include an RF/DC separator configured to receive the RF signal from the signal processing unit so as to separately output the DC signal and the RF signal, an RF splitter configured to split the RF signal inputted from the RF/DC separator into a plurality of signals, a plurality of amplitude shifters configured to adjust the amplitudes of the plurality of signals inputted from the RF splitter, and a plurality of phase shifters configured to adjust the phases of the plurality of signals respectively inputted from the amplitude shifters.

In some exemplary embodiments of the present disclosure, the antenna unit may include an RF/DC separator configured to receive the RF signal from the signal processing unit so as to separately output the DC signal and the RF signal, an RF splitter configured to split the RF signal inputted from the RF/DC separator into a plurality of signals, a plurality of phase shifters configured to adjust the phases of the plurality of signals inputted from the RF splitter, and a plurality of amplitude shifters configured to adjust the amplitudes of the plurality of signals respectively inputted from the phase shifters.

In some exemplary embodiments of the present disclosure, the antenna unit may include an envelope detector configured to detect an envelope level of the RF signal inputted from the RF/DC separator, and an antenna controller configured to control the amplitude shifters and the phase shifters using the signal applied from the envelope detector as a control signal.

In some exemplary embodiments of the present disclosure, the antenna controller may use the DC signal inputted from the RF/DC separator as a driving power source.

In some exemplary embodiments of the present disclosure, the signal processing unit may include an RF transmission/reception unit connected to the antenna unit through one transmission line, the RF transmission/reception unit transmitting, to the antenna unit, an RF signal obtained by performing frequency up-conversion on a baseband signal or performing a frequency down-conversion of the RF signal inputted from the antenna unit into a baseband signal, and a controller electrically connected to the RF transmission/reception unit, the controller generating a control signal adjusting the amplitudes or phases of the split signals.

In some exemplary embodiments of the present disclosure, the controller generates the control signal using an amplitude modulation scheme.

In some exemplary embodiments of the present disclosure, the RF transmission/reception unit comprises a DC level shifter configured to transmits, to the antenna unit, the frequency up-converted RF signal to which the DC signal is added.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a block diagram showing a configuration of an RFID reader according to an embodiment of the present disclosure;

FIG. 2 is a block diagram showing a configuration of an RF transmission/reception unit of FIG. 1; and

FIG. 3 is a block diagram showing a configuration of an antenna unit of FIG.

### DETAILED DESCRIPTION OF THE DISCLOSURE

Hereinafter, exemplary embodiments of the present disclosure will be described in detail with reference to the accompanying drawings.

FIG. 1 is a block diagram showing a configuration of an RFID reader according to an embodiment of the present disclosure.

Referring to FIG. 1, the RFID reader includes a signal processing unit having a controller 100 and an RF transmission/reception unit 200, and an antenna unit 300.

The antenna unit 300 transmits/receives an RF signal through a plurality of patch antennae. Each of the plurality of patch antennae is connected to a phase shifter and an amplitude shifter so that the radiation pattern of the antenna is dynamically controlled.

The RF transmission/reception unit 200 performs a frequency up/down-conversion function of the RF signal. That is, the RF transmission/reception unit 200 includes an RF reception unit, and an RF transmission unit. The RF reception unit removes a noise component of the RF signal received through the antenna unit and amplifies only a signal in a desired band. Then, the RF reception unit performs frequency down-conversion on the amplified signal and outputs the frequency down-converted signal to the controller 100. The RF transmission unit performs frequency up-conversion of data inputted from the controller 100 into an RF signal. Then, the RF transmission unit outputs the frequency up-converted signal to the antenna unit 300.

The controller 100 demodulates the signal received from the RF reception unit, or transmits the modulated signal to the RF transmission/reception unit 200.

The controller 100 controls radio communication between the RFID reader and a tag through a communication protocol, and periodically transmits an information request signal to the tag. The controller 100 analyzes and extracts tag identification information. In addition, the controller 100 generates a signal for controlling the phase and amplitude shifters of the antenna unit 300.

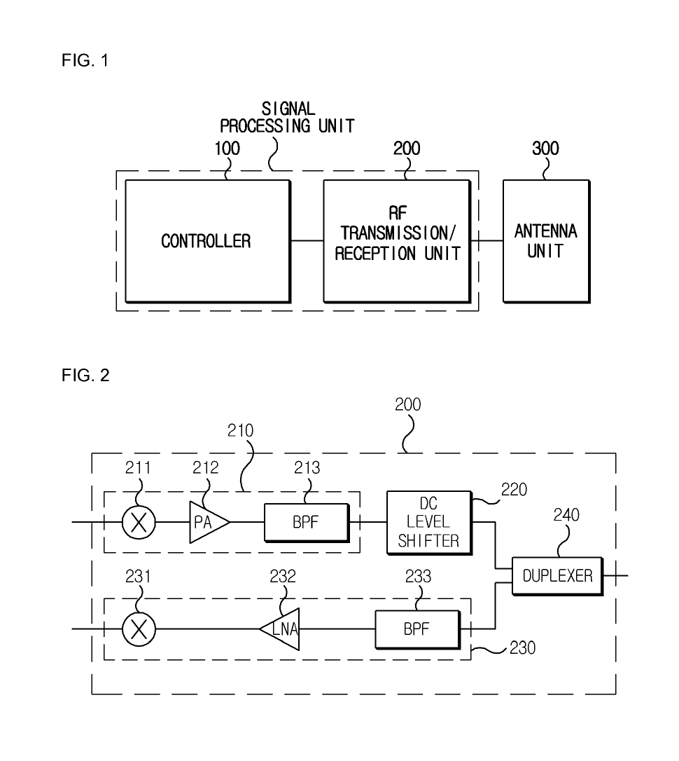

FIG. 2 is a block diagram showing a configuration of the RF transmission/reception unit of FIG. 1.

Referring to FIG. 2, the RF transmission/reception unit 200 includes an RF transmission unit 210, a DC level shifter 220, an RF reception unit 230 and a duplexer 240.

The RF transmission unit 210 includes a mixer 211, a power amplifier (PA) 212 and a band pass filter (BPF) 213. The mixer 211 performs frequency up-conversion on a baseband signal into an RF signal, and the PA 212 the RF signal to have sufficient power in the communication between the RFID and the tag. The BPF 213 removes an unnecessary frequency component and outputs only a signal in a desired frequency band.

The RF reception unit 230 includes a BPF 233, a low noise amplifier (LNA) 232 and a mixer 231. The BPF 233 removes an unnecessary frequency component and outputs only a signal in a desired frequency band. The LNA 232 restricts a noise component of an output signal of the BPF 233 and amplifies the restricted the output signal to a signal with a size, which can be processed by the controller 100. The mixer 231 performs frequency down-conversion of an RF signal into a baseband signal.

The DC level shifter 220 boosts the RF signal outputted from the RF transmission unit 210. That is, the DC level shifter 220 outputs an RF signal obtained by adding a DC voltage to the inputted RF signal. The DC voltage is integrated with the RF signal and transmitted to the antenna unit 300 through one transmission line. Thus, the DC voltage is used as a power source for driving the antenna unit 300.

The duplexer 240 separately transmits a signal to the path of a transmission terminal and the path of a reception terminal. The duplexer is a BPF and has three ports. The DC level shifter 220 and BPF 233 of RF reception unit are connected to both end ports of the duplexer 240, respectively, and the antenna unit 300 is connected to a central port of the duplexer 240. Thus, a signal outputted from the DC level shifter 220 is transmitted to only the antenna unit 300, and a signal received through the antenna unit 300 is transmitted to only BPF 233 of the RF reception unit 230.

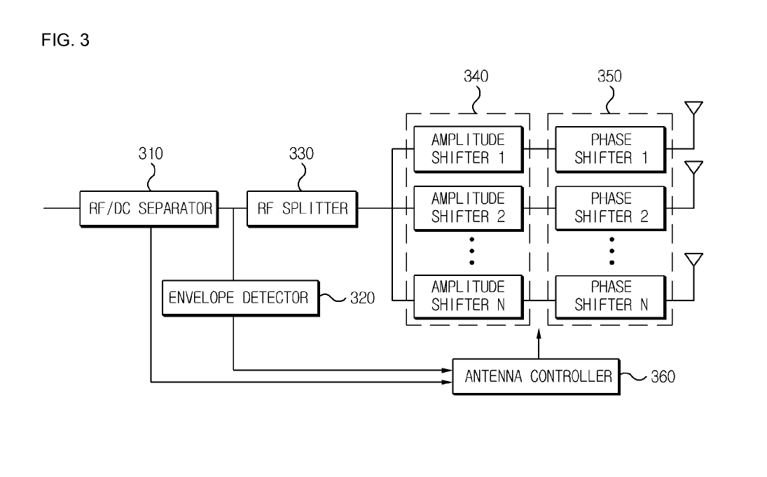

FIG. 3 is a block diagram showing a configuration of the antenna unit of FIG. 1.

Referring to FIG. 3, the antenna unit 300 includes an RF/DC separator 310, an envelope detector 320, an RF splitter 330, amplitude shifters 340, phase shifters 350, an antenna controller 360 and a plurality of patch antennae.

The RF/DC separator 310 receives the RF signal boosted by the DC level shifter 220. The RF/DC separator 310 separates a DC voltage component from the boosted RF signal and provides the DC voltage as a driving power source to the amplitude shifters 340, the phase shifters 350 and the antenna controller 360.

The envelope detector 320 receives the RF signal of which DC component is removed from the RF/DC separator 310. The envelope detector 320 decodes a control signal generated in the controller 100 by detecting the envelope level of the AM-modulated signal. The output signal of the envelope detector 320 is applied to the antenna controller 360.

The RF signal of which DC component is removed by the RF/DC separator 310 is applied to the RF splitter 330. The RF splitter 330 transmits the RF signal to the amplitude shifters 340 respectively through a plurality of transmission lines.

The amplitude shifters 340 and the phase shifters 350 improve the tag identification rate of the RFID reader by controlling the radiation pattern of the antenna.

The amplitude shifters 340 output RF signals with different amplitudes, respectively.

The phase shifters 350 electrically or physically generate a phase difference. For example, the phase shifters 350 may electrically generate a phase difference using a lumped element such as a capacitor, or may generate a phase difference by shifting the physical length of a microstrip transmission line (distributed element). The phase shifters 350 control the phases of the RF signals respectively transmitted through the plurality of patch antennae to be different from one another. The phase control can improve decrease in the reception rate according to the change in communication environment between the RFID reader and the tag, and the like. For example, if a metal wall exists in a direction on the path along which an RFID tag moves, a signal directly received from the RFID tag and a signal received by being reflected from the metal wall have different phases from each other. The RFID reader according to this embodiment, provided with the patch antennae having the radiation pattern with different phases, can receive the two signals having different phases, thereby improving the reception rate of a signal transmitted from the tag.

The antenna controller 360 receives the output signal of the envelope detector 320. The output signal of the envelope detector 320 is a control signal for controlling the amplitude shifters 340 and the phase shifters 350, and the control signal is generated by the controller 100. Accordingly, the degree of shift of the amplitude shifters 340 and the phase shifters 350 is determined.

The controller 100 of the RFID reader configured as described above controls radio communication between the RFID reader and the tag through a communication protocol, and periodically transmits an information request signal to the tag. The controller 100 analyzes and extracts tag identification information. In addition, the controller 100 generates a signal for controlling the phase shifters 350 and the amplitude shifters 340.

The control signal for controlling the phase shifters 350 and the amplitude shifters 340 and the signal for controlling radio communication between the RFID reader and the tag are modulated using an AM modulation scheme. In this instance, a blank time exists between the two signals, and hence the control signal for controlling the phase shifters 350 and the amplitude shifters 340 is first generated. After the blank time elapses, the signal for controlling radio communication between the RFID reader and the tag is generated.

The two signals modulated using the AM modulation scheme are boosted through the DC level shifter 220, and the boosted signals are transmitted to the antenna unit 300. The RF/DC separator 310 extracts only DC voltage components from the boosted signals, and provides the DC voltage as a driving power source to the amplitude shifters 340, the phase shifters 350 and the antenna controller 360.

The signal of which the DC component is removed is applied to the envelope detector 320 and the RF splitter 330. The envelope detector 320 detects the value of the envelope of the control signal and extracts the control signal for controlling the phase shifters 350 and the amplitude shifters 340. The control signal outputted from the envelope detector 320 adjusts the phase and amplitude of the RF signal by controlling the phase shifters 350 and the amplitude shifters 340 through the antenna controller 360. The signal for controlling radio communication between the RFID and the tag is applied to the plurality of amplitude shifters 340 through the RF splitter 330. The signal passes through the amplitude shifters 340 and the phase shifters 350, so that RF signals with different phases and amplitudes are transmitted through the plurality of patch antennae, respectively. Thus, it is possible to improve the transmission/reception rate in the radio communication between the RFID reader and the tag. Also, the power source for driving the antenna controller 360 is not supplied through a separate line, but the DC voltage is integrated with the RF signal through the DC level shifter 220 and transmitted to the antenna controller 360 through a transmission line, thereby preventing the interference phenomenon and simplifying the structure of the RFID.

According to embodiments of the present disclosure, the identification range can be extended by dynamically controlling an antenna radiation pattern of an RFID reader, and the communication between the RFID reader and tags can be stably performed by decreasing the error rate of transmission/reception data.

Also, when RF signals with different phases and amplitudes are transmitted to a plurality of antennae, respectively, it is sufficient to provide only one transmission line, so that it is possible to prevent the signal interference phenomenon and to simplify the structure of the RFID reader.

Although a few embodiments of the present disclosure have been shown and described, it would be appreciated by those skilled in the art that changes may be made in this embodiment without departing from the principles and spirit of the disclosure, the scope of which is defined in the claims and their equivalents.

What is claimed is:

1. A radio frequency identification (RFID) reader, comprising:
an antenna unit configured to split an input RF signal into a plurality of signals and respectively transmit the split signals through a plurality of antennae by setting the amplitudes or phases of the split signals to be different from one another; and
a signal processing unit connected to the antenna unit through one transmission line, the signal processing unit transmitting an RF signal to which a DC signal is added to the antenna unit.

2. The RFID reader of claim 1, wherein the antenna unit comprises:
an RF/DC separator configured to receive the RF signal from the signal processing unit so as to separately output the DC signal and the RF signal;
an RF splitter configured to split the RF signal inputted from the RF/DC separator into a plurality of signals; and
a plurality of phase shifters configured to adjust the phases of the plurality of signals inputted from the RF splitter.

3. The RFID reader of claim 1, wherein the antenna unit comprises:
an RF/DC separator configured to receive the RF signal from the signal processing unit so as to separately output the DC signal and the RF signal;
an RF splitter configured to split the RF signal inputted from the RF/DC separator into a plurality of signals;
a plurality of amplitude shifters configured to adjust the amplitudes of the plurality of signals inputted from the RF splitter; and
a plurality of phase shifters configured to adjust the phases of the plurality of signals respectively inputted from the amplitude shifters.

4. The RFID reader of claim 1, wherein the antenna unit comprises:
an RF/DC separator configured to receive the RF signal from the signal processing unit so as to separately output the DC signal and the RF signal;
an RF splitter configured to split the RF signal inputted from the RF/DC separator into a plurality of signals;
a plurality of phase shifters configured to adjust the phases of the plurality of signals inputted from the RF splitter; and
a plurality of amplitude shifters configured to adjust the amplitudes of the plurality of signals respectively inputted from the phase shifters.

5. The RFID reader of any one of claim 2, wherein the antenna unit comprises:
an envelope detector configured to detect an envelope level of the RF signal inputted from the RF/DC separator; and
an antenna controller configured to control the phase shifters using the signal applied from the envelope detector as a control signal.

6. The RFID reader of any one of claim 3, wherein the antenna unit comprises:
an envelope detector configured to detect an envelope level of the RF signal inputted from the RF/DC separator; and
an antenna controller configured to control the amplitude shifters and the phase shifters using the signal applied from the envelope detector as a control signal.

7. The RFID reader of any one of claim 4, wherein the antenna unit comprises:
an envelope detector configured to detect an envelope level of the RF signal inputted from the RF/DC separator; and
an antenna controller configured to control the amplitude shifters and the phase shifters using the signal applied from the envelope detector as a control signal.

8. The RFID reader of claim 6, wherein the antenna controller uses the DC signal inputted from the RF/DC separator as a driving power source.

9. The RFID reader of claim 7, wherein the antenna controller uses the DC signal inputted from the RF/DC separator as a driving power source.

10. The RFID reader of claim 1, wherein the signal processing unit comprises:
an RF transmission/reception unit connected to the antenna unit through one transmission line, the RF transmission/reception unit transmitting, to the antenna unit, an RF signal obtained by performing frequency up-conversion on a baseband signal or performing a frequency down-conversion of the RF signal inputted from the antenna unit into a baseband signal; and
a controller electrically connected to the RF transmission/reception unit, the controller generating a control signal adjusting the amplitudes or phases of the split signals.

11. The RFID reader of claim 10, wherein the controller generates the control signal using an amplitude modulation scheme.

12. The RFID reader of claim 10, wherein the RF transmission/reception unit comprises a DC level shifter configured to transmits, to the antenna unit, the frequency up-converted RF signal to which the DC signal is added.
